(19) United States
(12) Patent Application Publication
(10) Pub. No.: US 2023/0068755 A1
(43) Pub. Date: Mar. 2, 2023

(54) DISPLAY OF OCEAN-BASED GEAR POSITION TO USERS

(71) Applicant: Blue Ocean Gear, Inc., San Mateo, CA (US)

(72) Inventors: Douglas John Traeger, San Rafael, CA (US); William Frederick Hilary Morton, San Francisco, CA (US); Kevin Michael Johnson, San Francisco, CA (US); Kortney Noell Opshaug, Redwood City, CA (US)

(21) Appl. No.: 17/895,706

(22) Filed: Aug. 25, 2022

Related U.S. Application Data
(60) Provisional application No. 63/239,812, filed on Sep. 1, 2021.

(51) Int. Cl. G01S 19/03; G06F 3/14; B63B 49/00

(52) U.S. Cl. CPC G01S 19/03; G06F 3/14; B63B 49/00; H04W 4/14

(57) ABSTRACT

Ocean-based gear equipped with Global Positioning System (GPS) shares position to either single or multiple users. Position data from an ocean-based device are sent either to a cloud-hosted database or vessel transceiver, then displayed on either a mobile app via multiple login accounts, a vessel-mounted GPS plotter that is capable of sharing data over the internet, or a satellite-connected mobile device capable of receiving and displaying Short Message Service (SMS) messages or emails. The Vessel Transceiver device is designed to share data from gear to vessel via radio frequency, as well as vessel to vessel via satellite network, without internet connectivity. Position data are provided to either one user or multiple users on the ocean or on land via various communication arrangements.

### RELATED APPLICATIONS

The present patent document claims the benefit of the filing date under 35 U.S.C. § 119(e) of Provisional U.S. Patent Application Ser. No. 63/239,812, filed Sep. 1, 2021, which is hereby incorporated by reference.

### TECHNICAL FIELD

The disclosure relates to displaying ocean-based gear position to either single or multiple users.

### BACKGROUND

Fixed-gear fishing involves vessels setting traps, nets, longlines, or other fishing gear in the water for long periods of time. Buoys are typically attached to the gear at the surface to mark the locations, so the fisher can retrieve and harvest periodically during the fishing season. Unfortunately, multiple fishing vessels often operate in the same vicinity as other fishers, either transiting through, setting gear, or dragging trawling gear behind their boat. In conditions where visibility is low, such as fog or rough seas, the buoys can be hard to see. Often, the crew on the other vessels do not know or cannot see that there is fishing gear in the water around where they are operating or traveling. If it is a fishing vessel, they may also set their own gear on top of the gear that is already in the water. This can result in a situation known as “gear conflict”, where gear set in the water either becomes entangled with another set of gear, entangled in the propeller or other parts of the boat traveling through the gear, or the gear is separated from its buoys by the boat traveling through. When this happens, one or more sets of gear are often cut free, sinking to the bottom to become ocean pollution, and continuing to capture species that are never harvested in a cycle known as ghost fishing. This loss of gear is costly both in time and financial loss to all vessels involved.

Most fishing vessels are equipped with a GPS plotter system, which is either a hardware device or a personal computer running software that displays GPS positions on a screen with a map display. Most GPS plotter devices or software packages allow the user to input positions or waypoints. This input is manual or occurs automatically through file import or other data interface provided by the device or software. Currently, some fishers mark the GPS locations manually of approximately where they initially set their gear. Sometimes, they share the location by manually sending GPS coordinates in an email message with other fishing vessels in the area. However, surface gear can move great distances (>1 km per day), so the positions where the gear was initially set are not always accurate through time.

Some fishing gear is marked with GPS-enabled tracking buoys that communicate periodic position updates from the water surface via either satellite or radio transmission. Currently, these data are accessible only by a single user. For those buoys with satellite modems, the buoy sends data to a satellite and cloud-based database, and the vessel uses an onboard satellite modem to receive buoy data messages. Some fisheries use Automatic Identification System (AIS) systems to locate and share their gear positions. This uses a special radio frequency band that all vessels have receivers for in the event of emergency vessel location. However, using this frequency to mark and transmit the locations of fishing gear is currently illegal in the United States. AIS is also limited in the distance from which it can be detected, as it is dependent on a radio frequency for transmitting and receiving signals, and any boat with an AIS receiver onboard can detect any AIS signal directly in its region.

### SUMMARY

By way of introduction, the preferred embodiments described below include methods, systems, instructions, and computer readable media for displaying ocean-based gear position to users. Fishing gear-based data (e.g., buoy position) is transmitted to assist in recovery and/or avoiding damage. In one approach, a vessel may select with whom to share fishing gear-based data for their fishing gear. In another approach, the vessel receives the fishing gear-based data and forwards, either directly or indirectly, the fishing gear-based data to other vessels. In yet another approach, a vessel transceiver is provided on the vessels for sharing the fishing gear-based data. As another approach, the vessel receives the fishing gear-based data from the fishing gear via radio communications, and then forwards fishing gear-based data via satellite or cloud communications to the other vessels.

In a first aspect, a vessel transceiver system is provided for fishing gear position. A radio antenna is on a first vessel. A satellite modem is on the first vessel. The radio antenna and/or the satellite modem are configured to receive position information of ocean-based fishing gear from the ocean-based fishing gear. The radio antenna and/or the satellite modem are configured to provide the position information to a second vessel.

In a second aspect, a method is provided for sharing fishing gear data. The fishing gear data is received, via first electronic communications, from the fishing gear of a first vessel. An entity of the first vessel with a user interface establishes other vessels with which to share the fishing gear data. The fishing gear data is shared with the other vessels via second electronic communications.

In a third aspect, a method is provided for sharing fishing gear data. The fishing gear data is electronically received from the fishing gear of a first vessel at the first vessel. The fishing gear data is shared with the other vessels by electronic communication from the first vessel.

In a fourth aspect, a system is provided for sharing of ocean-based fishing gear data. A radio transmitter is on ocean-based fishing gear. A first transceiver on a first vessel is configured to receive data from the radio transmitter. A first satellite modem on the first vessel is configured to transmit the data to a server or database. A second transceiver on a second vessel is configured to receive the data from the server or database.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 illustrates an example of a fishing vessel traveling toward a set of multiple fishing traps and buoys.

FIG. 2 illustrates an example of a GPS-enabled buoy with satellite transmission capability sending data to a cloud-based database, with download of that data to one or more mobile devices for display by a mobile application.

FIG. 3 illustrates an example of a GPS-enabled buoy with satellite transmission capability sending SMS data for sharing buoy position.

FIG. 4 illustrates an example data flow using a cloud-based database for sharing buoy position.

FIG. 5 illustrates an example of a GPS-enabled buoy with satellite transmission capability where the buoy position is shared from the primary user via a cloud database.

FIG. 6 illustrates an example data flow for the embodiment of FIG. 5.

FIG. 7 illustrates an example of a GPS-enabled buoy using radio communication with the primary vessel, which shares via satellite communication.

FIG. 8 illustrates an example data flow for the embodiment of FIG. 7.

FIG. 9 is a block diagram of one embodiment of a vessel transceiver for sharing buoy position information.

FIG. 10 illustrates another example of sharing buoy position using the vessel transceiver of FIG. 9.

### DETAILED DESCRIPTION

In addition to problems with inaccuracy and illegality, fisheries management has need of knowledge regarding where and how much gear is set in areas of interest. Currently, to obtain this information during a fishing season, department personnel are physically present out on the water to visually inspect gear. This uses significant time and financial cost.

Many boats operate far out on the water without internet access. These same vessels need access to gear locations belonging to other fishers so they don't run through those areas.

A solution is needed that offers:
a) The ability to share real-time information of gear positions with other vessels that may or may not have internet access and that are in the same area, if the owner of the gear chooses to allow such access.
b) The ability to share real-time information of gear positions with enforcement entities to allow monitoring of gear on the water from land, if the owner of the gear chooses to allow such access or if required by regulation.
c) The ability to have multiple entities viewing position data to avoid those areas that have gear in the water, drastically reducing occurrences of gear conflict, and protecting the assets of each entity.

A communications system allows multiple methods of sharing ocean device positions with access for one or more users. This is accomplished through various combinations of tracking buoys that transmit position of gear on the water via either satellite or radio transmission, cloud-based databases, GPS plotting devices or software onboard vessels, buoy-specific application display software, and/or onboard satellite mobile devices.

For reference herein, the person, vessel, or entity that owns and/or sets the tracking buoys is referred to as a primary user. The people or vessels that the data will be shared with are referred to as secondary users. Further, GPS is used in the examples herein. Any global navigation satellite systems (GNSS) may be used, such as GPS, BeiDou, Galileo, GLONASS, IRNSS, or QZSS.

With existing GPS-enabled fishing buoys, data can be transmitted via satellite to a cloud-based database designed to receive the specific protocol and message format provided by the buoy. From the database, a front-end application, program, or browser running on a personal computing device, smart phone or GPS chart plotter displays the relevant sensor data, including the position of the buoy. Application, program, or browser are used in the examples herein, but other computer instructions for display of position data may be used. In one example, this application is referred to as the buoy application. Each buoy is associated with a unique identifier embedded in its onboard firmware. Access to the display of a particular buoy on the buoy application is achieved via restricted login using a specific and unique username and password, where the primary user is associated with the buoy identifier. One or more (e.g., multiple) secondary users can be granted the ability to view the data for the same buoy on another instance of the buoy application on their own device, allowing the data to be shared. The shared data can be restricted to the position of the device only or expanded to allow access to all or any sub-set of buoy sensor data.

In yet another instance, the primary user's vessel does not have internet capability but instead has a satellite-capable mobile device that is able to receive Short Message Service (SMS) messages or emails. The GPS-enabled buoy transmits its position data via satellite to a cloud-based database. The fisher can request data via their mobile device, triggering the database to send a list of available options to view GPS coordinates for buoys in the area. This information can either be text-based or transferred to a mobile application that imports the coordinates and displays on a map. Multiple secondary users equipped with satellite-capable mobile device can be granted the ability to view the same buoy information, allowing the data to be shared. These systems and methods allow fishers with gear on the water to share the positions of that gear with other entities either on or off the water, depending on their individual capabilities with respect to internet access and displays.

For primary users that wish to display and share their data using an onboard GPS plotter, two methods may be used. For the first method, for GPS-enabled buoys that transmit data via satellite, a vessel with both internet access and a personal computer running both a GPS chart plotter application that displays nautical charts and the real-time position of the vessel, readily available on the market and referred to as the plotter application, as well as the buoy application are used. The buoy application can generate position data that can be imported by the plotter application, allowing the display of the buoy positions on the plotter application of the primary user's vessel. At the same time, the position data can be uploaded to a cloud-based database via the internet, then downloaded to any secondary user's vessel granted access to the file to be displayed on a computer running a compatible plotter application. This allows all vessels given access to the data to display the buoy locations on their onboard plotter system.

For the second method, for GPS-enabled buoys that transmit data via radio frequency (RF), a vessel equipped with a vessel transceiver and a personal computer running a plotter application are used. The vessel transceiver onboard the primary user's boat is equipped with a compatible RF antenna and transceiver hardware to receive the buoy position data and convert the data to a format compatible with either a hardware GPS plotter or computer running a plotter application. Similar to the first method, if the vessel has internet access, the position data can then be generated by the vessel transceiver and uploaded to a cloud-based database, for download by any vessel granted access to display on their own plotting device.

In another instance, the primary user's vessel does not have internet access, and the secondary user's vessel also does not have internet access. In this embodiment, the vessel transceiver has a satellite modem to transfer GPS buoy data to a cloud-based database. If the secondary user also has a vessel transceiver with a satellite modem, the same data can be downloaded via the satellite modem to the secondary user's vessel and displayed on their onboard plotter application.

For the purpose of explanation, the examples of a GPS-enabled fishing buoy and a fishing vessel will be used. Embodiments can also include other ocean sensor devices and other ocean-going vessels.

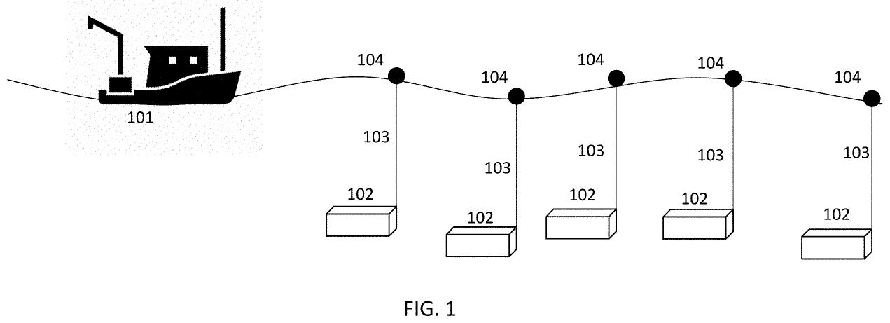

Fixed-gear fishing vessels may set their gear in particular regions of the ocean during the season for their species. Fishing gear may involve traps, nets, longlines, or other types of apparatus used to capture marine species. Traps are used as an example of fishing gear in FIG. 1. FIG. 1 shows several traps (102) set in a row, each with a line (103) attached to a surface buoy (104). The figure also shows another vessel (101) traveling through the same area, but the vessel crew does not know about or cannot see the buoys on the surface, whether it is due to inattention or low visibility from darkness, fog, large swells, or currents pulling the buoys just under the surface. In one situation, the propeller from the vessel may become entangled with the lines (103). In another situation, the vessel is pulling a weighted net or trawler mechanism that may become entangled with the lines (103). In either scenario, the tangled gear can cause damage to the boat or its gear, and the vessel may have to cut the gear free. In another situation, the boat or motor may cut the line directly upon encountering it. Severing the lines (103) connecting to the traps (102) below will make the fishing gear very challenging, if not unlikely, to be retrieved. Severed lines (103) connected to either buoys (104) or traps (102) become entanglement hazards for boats and marine mammals and continue to capture marine species that die and become bait for more species to become captured, a cycle known as ghost fishing.

In embodiments with multiple traps (102) connected as a string with a fewer number of buoys (104) through any configuration of lines (103), similar scenarios may arise. In other embodiments, the fishing gear is of a different type other than traps or fixed-gear. Similar scenarios exist where vessels in transit through the region of the gear can either tangle the gear or sever the lines. For example, towed fishing gear or free-floating fishing gear is used. One or more buoys for the free floating or towed fishing gear provide location data, which may be communicated to secondary users as well as primary users.

A buoy system has been developed that uses Global Positioning System (GPS) sensing to determine the buoy's position and transmit the position via satellite or radio communications links. An example of such a buoy system is disclosed within U.S. Pat. No. 10,654,544, which is incorporated by reference herein in its entirety. The received position can then be displayed on a mobile application on a smart device or on a web interface on a computer.

In various embodiments, electronic communications are used to communicate between buoys, vessels, satellites, mobile devices, and/or computers. Various electronic communications may be used, such as radio (direct or broadcast with radio frequency), satellite (e.g., satellite modem or satellite phone), short message service or cellular, short wave, or another now known or later developed wireless communication. Communications between devices on a same vessel or same location may use wired electronic communications, such as serial, ethernet, buss, or parallel. Any format may be used. Receivers, transmitters, and transceivers are the hardware performing the electronic communications, such as satellite modems as transceivers for satellite signals or radio transceivers as transceivers for terrestrial radio communications.

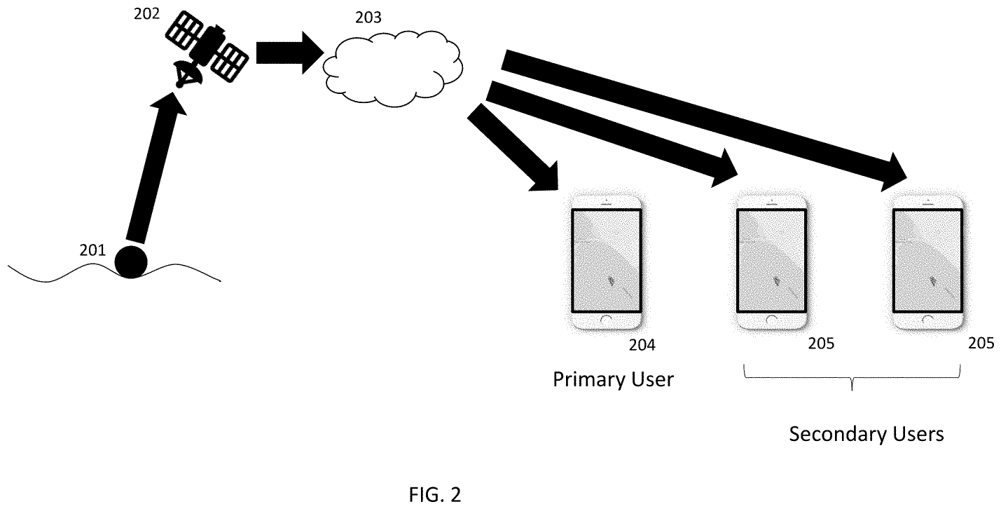

FIG. 2 shows a GPS-enabled satellite buoy (201) transmitting its position and/or other data via a satellite (202), where the data is then stored in a cloud-based database (203) or transmitted through one or more servers forming the cloud-based system. Data are then downloaded from the database or transfer through servers via satellite-based internet available onboard a vessel to a mobile device (204) that has a mobile application to display buoy position on a map. Satellite internet may be provided via satellite communications, such as using low, medium, or high earth orbit satellites (e.g., use Iridium or Starlink). In another embodiment, the position data are displayed on a computer running a web-based application, program, or browser. Each primary user has a unique account with secure username and password protection to access the data from their buoys. By default, the position data are only accessed by the primary user and are not shared.

If the primary user chooses to do so, it is possible to share the same data from a primary user's buoy with one or more secondary users (205) that have different login accounts. The primary user is an entity for the vessel, such as the captain, owner, operator, administrator, or crew. This entity can control the sharing. In this way, position data are shared with other vessels. For this data flow, either Internet or cellular service is used. Any computer network transmission protocol and physical media may be used, such as cellular, satellite, or another.

A user interface allows the primary user to select what data to share and with whom to share. The user interface may be generated as part of a local application or as part of a cloud-based program (e.g., browser-based control managed by a server). A local or remote processor (e.g., processor on the vessel or mobile device of the vessel or a processor of a server) generates the user interface. For example, the user interface is used while on land or is used on a vessel using an internet connection (e.g., satellite modem). The sharing may be by category, such as selecting to share with any users within a given distance or at a given fishery. The primary user may be provided with a list of secondary users and may select or deselect secondary users on the list to identify with whom to share. The primary user may indicate whom not to share. Where government or fisheries regulation requires sharing with the government or fisheries, the ability to turn off sharing may not be provided.

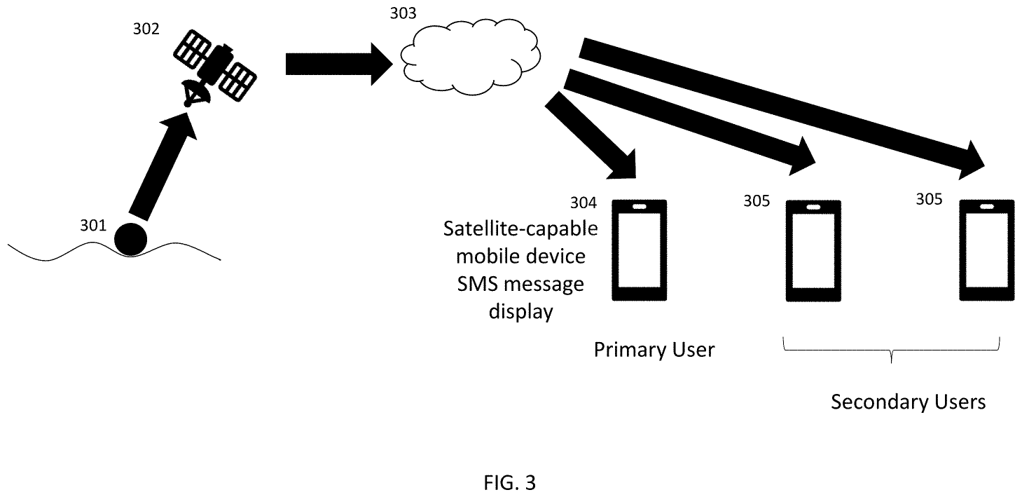

In another embodiment, the vessel does not have satellite-based internet available. Instead, the vessel only has a satellite-capable mobile device that can send and receive SMS messages. In one embodiment, this mobile device is a satellite phone. FIG. 3 illustrates one embodiment of sharing buoy data with other users. In FIG. 3, a GPS-enabled buoy (301) transmits position data via satellite (302) to a cloud-based database (303). A user on a vessel with a satellite-capable mobile device (304) can send a request to the database to display the buoy position. Alternatively, the position data is pushed to registered users (e.g., primary user via the mobile device (304) and/or any secondary users via mobile devices (305). If provided with appropriate credentials for access, other vessels with satellite-capable mobile devices (305) can also access the same buoy position information via SMS messaging. In this way, the position data are shared with multiple vessels, even without internet connectivity.

An SMS message is configured to display the GPS coordinates in text format. For example, the text of the message includes the longitude, latitude, and identification information. The users read the message. The position data may be manually entered into the GPS plotter or other chart plotter program or device. In another embodiment, the mobile device (304, 305) receives the buoy position information via email. In another embodiment, the primary user may use a GPS plotter to display while the secondary user uses a satellite-capable mobile device (305) with SMS messaging for a text display of the same sensor data. A program or application may read the SMS messaging for automated link to a chart or GPS plotter program instead of manual entry.

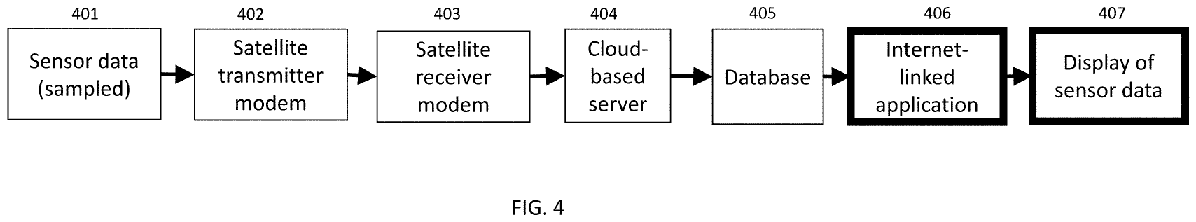

FIG. 4 is an example of a representation of a GPS-enabled buoy with satellite transmission capability sending data (401) to a cloud-based database (405), then downloading those data (401) to the primary user's vessel, which has a personal computer running both a buoy location application and a GPS plotter application to display (407) the buoy position on the GPS plotter map. Position data are then uploaded to a cloud-based database and downloaded by other secondary users with personal computers running GPS plotter applications for display of the buoy positions.

The data are created when a buoy or other ocean device samples an onboard sensor (401). These data are processed by the onboard electronics and firmware, which results in the onboard satellite modem (402) and antenna transmitting the data (401) using the appropriate frequency to be received by the orbiting satellite system's receiver modem (403) (e.g., receiver of a transceiver). The satellite receiver system transfers the data (401) to its cloud-based server (404), where the data (401) is then transferred to a database (405) that is capable of reading in and storing the sensor data (401). An internet-linked application (406) that has been logged into by the primary user, via a computing device of the primary user (e.g., a mobile device, transceiver, or personal computer), is able to download the appropriate data (401) from the database (405) and display (407) on the application or display screen. The application (406) and display (407) can be accessed by either a primary user with their secure login and password, or a secondary user with a separate login and password, via a computing device (e.g., mobile device or personal computer) associated with the user. In other words, the secondary user may access the database (405) using an internet-linked application, program, or browser for local display (407) of the position data (401).

Most boats or ocean-going vessels utilize onboard GPS chart plotter devices to display the real-time location of their boat with respect to nautical charts or other regional information. Some GPS chart plotters are hardware-based, while others are software-based and run on personal computers. It is possible to display other GPS-based information on some chart plotters, including fishing gear locations. The position data (401) from one or more buoys is communicated to the plotter to incorporation into the display of the plotter.

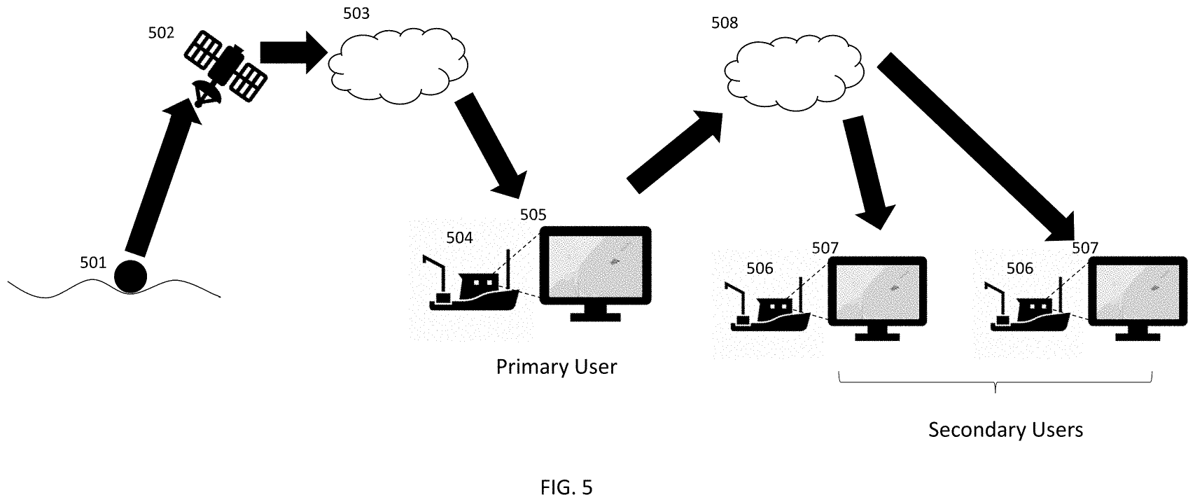

FIG. 5 shows the GPS-enabled buoy (501) transmitting position data via satellite (502) to a cloud-based database (503) for buoy data. In this embodiment, the data are downloaded via the internet to a computing device (e.g., personal computer (505)) onboard a vessel (504) running two types of software applications:

1. A web-based application that can process the buoy position data directly from the database
2. A GPS plotter application that displays vessel and gear locations on a monitor

In this embodiment, the web-based interface produces a block of data containing the buoy position that can be imported by the GPS plotter application and subsequently displayed automatically on the same plotter map display as the vessel. The same position data can be uploaded to a cloud-based database (508) for the plotter software via the satellite-based internet connectivity available on the boat (504). If provided with appropriate credentials for access, other vessels (506) with the same capabilities for internet connectivity and GPS plotter software running a computing device (e.g., personal computer (507)) onboard the vessel can download the position data to be imported into their GPS plotter software and displayed on their plotter monitor. In this way, the data are shared between users and displayed on their GPS plotters.

In another embodiment, buoy sensor data are also transferred with the position data to be displayed on the plotter map. In another embodiment, the GPS plotter may receive the buoy data directly into their hardware system via wireless transfer. In another embodiment, the computer (505, 507) running the web-based interface for the buoy locations is connected by a serial cable to a hardware-based GPS plotter. In another embodiment, the cloud-based database (503) for buoy data is also capable of downloading position data directly to other secondary user vessels for import into their GPS plotter without using the secondary database (508) (compare FIG. 5 with FIGS. 2 and 3).

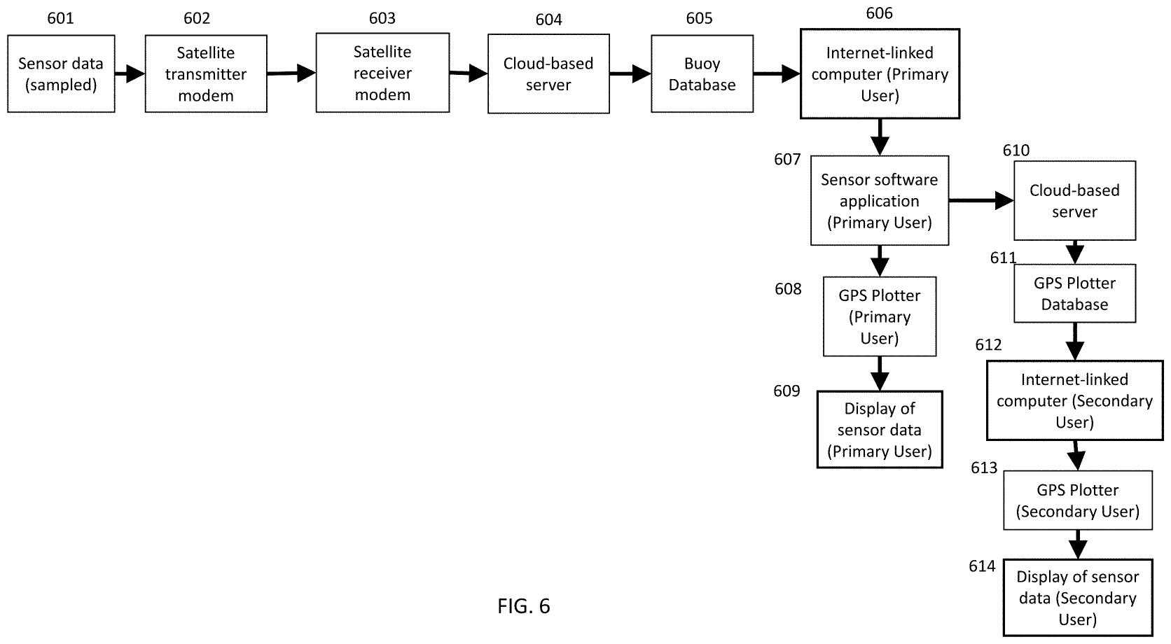

FIG. 6 illustrates an example of a representation of a GPS-enabled buoy with radio transmission capability sending data to a vessel-mounted radio transceiver on the primary user's vessel, which connects to a personal computer running both a buoy location application and a GPS plotter application to display the buoy position on the GPS plotter map. Position data are then uploaded to a cloud-based database and downloaded by other secondary users with personal computers running GPS plotter applications for display of the buoy positions.

The data (601) are created when a buoy or other ocean device samples an onboard sensor. These data (601) are processed by the onboard electronics and firmware of the buoy, which results in the onboard satellite modem (602) and antenna transmitting the data (601) using the appropriate frequency to be received by the orbiting satellite system's receiver modem (603) (e.g., receiver of a transceiver). The satellite receiver system transfers the data (601) to its cloud-based server (604), where the data (601) is then transferred to a database (605) for buoy data. The database (605) is capable of reading in and storing the sensor data (601). The primary user's internet-linked computer (606) then downloads the relevant sensor position data in a format to be imported by the sensor software application (607). A block of data automatically created by this software is then transferred to a separate plotter software program (608) on the same computer via a software interface such as file import or API (Application Programming Interface). Alternatively, the plotter software program (608) receives the data (601) without the intervening application (607). In either case, the plotter software or program (608) then displays the sensor data on the monitor (609). Periodically or on command, the sensor data (601) is uploaded to the cloud-based server (610) and stored in a database (611) for GPS plotter files and data, ready to be downloaded by others. Alternatively, the application (607) communicates authorization to share to the server (604) and/or database (605), which acts as the server (610) and database (611). Periodically or on command, a secondary user's internet-linked computer (612) then downloads the relevant sensor data (601) to be imported by the secondary user's GPS plotter (613) and then displayed on the monitor (614).

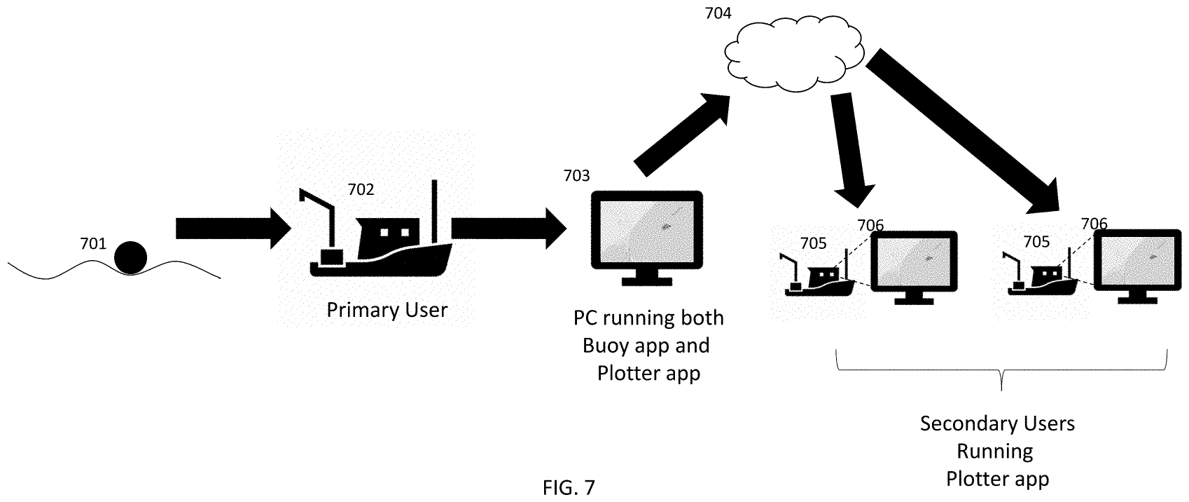

As some GPS-enabled buoys do not have satellite transmission capability but instead have radio transmission capability, another embodiment is used for communicating and displaying these data. FIG. 7 shows a GPS-enabled radio buoy (701) transmitting its position data via radio link (radio frequency) to a vessel-mounted radio transceiver onboard the boat (702). The vessel-mounted radio transceiver is a device that is capable of receiving radio frequency signals from the GPS-enabled buoy (701) and translating the buoy message to a format readable by any GPS plotter (e.g., NMEA0183). In one embodiment, the message is received by the GPS plotter on a computer (703) via cable (e.g., serial line or ethernet). In another embodiment, the message is received from the vessel transceiver wirelessly (e.g., Wi-Fi or Bluetooth). The software of the plotter then generates data containing the buoy position information and transmits the data via the internet to a cloud-based database (704) or server. If provided with appropriate credentials for access, other vessels (705) with the same capabilities for internet connectivity and GPS plotter software running on a personal computer (706) onboard the vessel (705) can download the position data to be imported into their GPS plotter software and displayed on their plotter monitor. In this way, the data are shared between users and displayed on their GPS plotters.

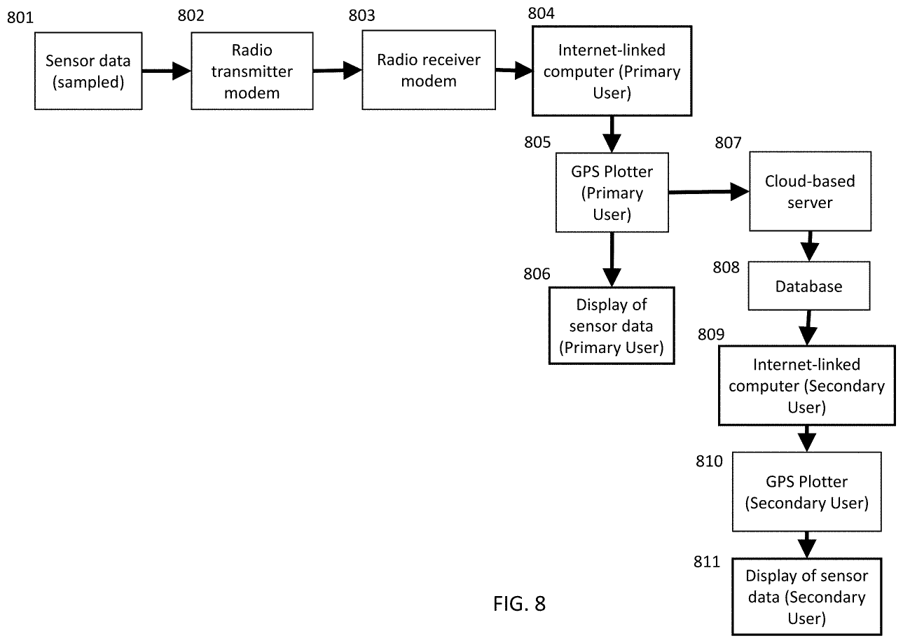

The data flow for the case described above is shown in FIG. 8. The data (801) are created when a buoy or other ocean device samples an onboard sensor. These data (801) are processed by the onboard electronics and firmware of the buoy, which results in the onboard radio modem (802) and antenna transmitting the data (801) using the appropriate frequency to be received by the primary user's radio transceiver modem (803) mounted onboard the vessel. The radio transceiver modem electronics and firmware process the data (801) and put the data (801) into a format that can be imported by a GPS plotter. In one embodiment, the transceiver modem (803) is connected via a serial cable to the primary user's internet-linked computer (804). In another embodiment, the transceiver modem (803) uses wireless networking technology, including but not limited to Wi-Fi or Bluetooth, to transmit data to the computer (804). The plotter software program (805) then displays the sensor data (801) on the monitor (806). Periodically or on command, the sensor data (801) can be uploaded to the cloud-based server (807) and stored in a database (808), ready to be downloaded by others. Periodically or on command, a secondary user's internet-linked computer (809) then downloads the relevant sensor data (801) to be imported by the secondary user's GPS plotter (810) and then displayed on the monitor (811).

The primary and/or secondary user controls the frequency of download and/or upload (e.g., for push). Alternatively, a default frequency is set. For command, the user triggers the command or establishes the criteria for the command (e.g., period of pull request).

In one embodiment, an existing processor, such as a computer implementing the chart plotting, mobile device, tablet, and/or computer provides the user interface to control sharing and/or receives the data from the buoy and generates an output (e.g., display or transmission). The software and/or firmware configures the hardware for this operation.

In another embodiment, a device allows the vessel to communicate with sensors on the water, as well as with other devices on the same and/or additional vessels. For example, the device is used as any of the computers, mobile devices, or applications discussed herein. The device may be added to the vessel, such as a box mounted to a rack and connected to one or more other devices on the vessel.

The communication may be without internet connection being required or uses internet connection. This device, referred to as a vessel transceiver, allows two-way communication between the vessel and the buoy or fishing gear, and also communication with a cloud-based database. For a primary user, both communication paths will be utilized. For a secondary user (1) with a Vessel Transceiver and no sensor or tracked fishing gear of its own or (2) with a Vessel Transceiver also being used to show buoy or gear location for another vessel, only the communication between the Vessel Transceiver and the cloud-based database will be utilized. The location of the Vessel Transceiver may or may not be communicated and used in display for the primary and/or secondary users.

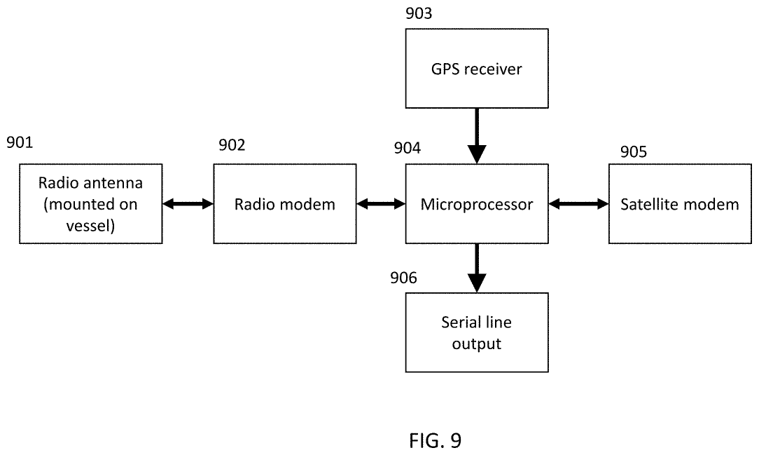

The Vessel Transceiver and corresponding vessel-mounted radio transceiver main components are represented in FIG. 9. The vessel transceiver connects to a GPS or chart plotter to display the buoy position, and also has a satellite modem to send data to the cloud. Position data are then uploaded to a cloud-based database and downloaded by other secondary users with personal computers running GPS plotter applications for display of the buoy positions.

An antenna (901) is mounted onto the primary user's vessel and tuned to the same frequency that the buoy transmits to receive the buoy data, and a cable connects the antenna (901) to an electronics enclosure (housing) to transfer the signal. In another embodiment, the antenna (901) is inside the electronics enclosure. Inside the electronics enclosure are a radio transceiver modem (902), a GPS antenna and processor (903), a microprocessor (904), and a satellite modem (905). The radio transceiver modem (902) processes the radio signal. The optional GPS antenna and processor (903) determine the position of the vessel transceiver. The microprocessor (904) runs firmware to process the incoming data and translate the buoy message to a format readable by any GPS plotter (e.g., NMEA0183). The satellite modem (905) transmits or read files to and from the cloud. A serial output cable (906) transfers files to another computer or GPS plotter device onboard the vessel. Alternatively, the vessel transceiver includes a display for outputting a map, text, or other position information for one or more buoys for that vessel (primary user) and/or for buoys of other vessels (secondary user). Onboard the Primary Vessel, the Vessel Transceiver can receive data from the GPS-enabled radio buoy and translate the buoy data into a format readable by a GPS plotter for display on the primary user's vessel. The data can be uploaded to a cloud-based database either via internet connection, via SMS, or via the Vessel Transceiver satellite modem (905). Onboard a secondary user's vessel, the vessel transceiver downloads the data from the cloud-based database either via internet connection, via SMS, or via the Vessel Transceiver satellite modem (905) and subsequently displayed on the secondary user's Chart Plotter or another display.

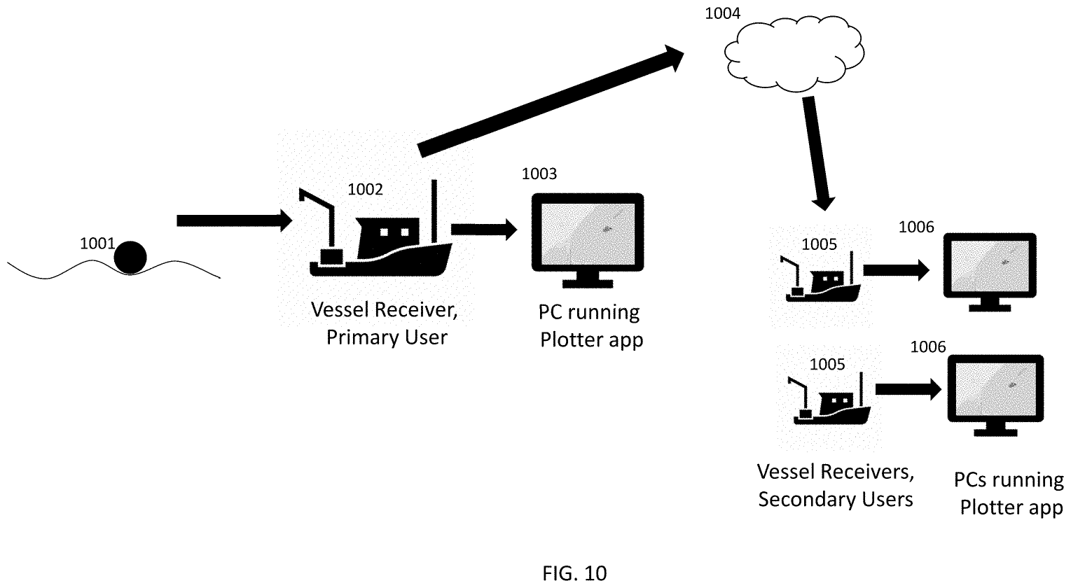

Another embodiment is shown in FIG. 10, where the buoy is not equipped with satellite transmission capability, and the Primary and Secondary vessels do not have internet connectivity available. FIG. 10 is of a representation of the components of a vessel transceiver for use on a primary user's boat and/or a secondary user's boat.

In this embodiment, a GPS-enabled buoy (1001) with radio transmission sends its position data to a radio-frequency Vessel Transceiver (1002) on the primary user's boat for display on the primary user's GPS plotter or computer (1003) running the plotter application. The Vessel Transceiver (1002) has a satellite modem that can upload data to the cloud (1004). This data can then be downloaded from the database (1004) to a secondary user's vessel (1005) via a similar Vessel Transceiver device that has a satellite modem onboard to receive the files. The position data can then be read displayed by the vessel transceiver or in by a GPS plotter (1006) connected to the vessel transceiver on the secondary user's boat and displayed on the monitor.

In an embodiment, the data to be shared with the secondary user is buoy position only. Other data, such as the identification of the primary user for the buoy, may be displayed or not, based on control by the primary user. In another embodiment, the data to be shared with the secondary user includes buoy sensor data in addition to position, such as data about counts in the traps. In another embodiment, the data being transmitted and shared are sensor data taken by a buoy or other ocean-based platform, including but not limited to temperature, depth, acceleration, or salinity.

In another embodiment, the secondary user's Vessel Transceiver uses the GPS position determined onboard the Vessel Transceiver device to only provide data for buoys that are within a defined radius of the secondary user. The secondary user, primary user, or network administrator may set the radius.

In another embodiment, data concerning the primary user's fishing gear that are shared with secondary users are transmitted and/or displayed as a broader area around the exact location of the gear so as to avoid sharing exact position information. For example, a fencing is used where the location is shown in a radius (e.g., 100 yards, 500 yards, or mile). In another embodiment, the regions where fishing gear is deployed are defined as areas to be avoided in route-planning software to guide secondary user vessels around regions with gear. The plotter or route guidance system (program or application on a computer or mobile device) on the secondary user vessels uses the regions and/or fishing gear location to plot a route (route plan) where the route avoids the regions or locations of the fishing gear of the primary and/or other vessels. Similarly, the primary vessel plans routes to avoid fishing gear locations or regions of other vessels based on locations received from the other vessels. As another embodiment, the location is only shown when the secondary vessel is close (e.g., 1 mile or 100 yards) to the buoy.

In another embodiment, data from other sensors are incorporated into the position data displayed on the Chart Plotters of either the primary user or secondary user. For example, temperature data is provided and displayed. In another embodiment, the data being transmitted are location information received acoustically from underwater devices.

In another embodiment, the Vessel Transceiver can determine the type of communication protocol required by the display device and automatically adjust the message format. In another embodiment, the Vessel Transceiver can bridge data between the fishing gear or buoy and the cloud when the buoy or other sensor device is set to transmit in a certain protocol.

As disclosed herein, a computing device, computer, or processor may refer to a smart phone, a mobile phone, a personal digital assistant (“PDA”), a tablet computer, a notebook computer, a voice recognition device, a workstation, a server, a personal navigation device (“PND”), a portable navigation device, and/or any other known or later developed mobile electronic device. In certain examples, the computing device is installed or transported in or on a vehicle (e.g., the primary or secondary user's boat) or transported by a user of the boat.

An exemplary computing device may include a controller or processor, a memory, an input device, a communication interface, position circuitry, and a display. Additional, different, or fewer components are possible for the computing device.

The controller and/or processor of the computing device may include a general processor, digital signal processor, an application specific integrated circuit (ASIC), field programmable gate array (FPGA), analog circuit, digital circuit, combinations thereof, or other now known or later developed processor. The controller and/or processor may be a single device or combinations of devices, such as associated with a network, distributed processing, or cloud computing.

The controller and/or processor may also be configured to cause the computing device to at least perform at least one of the methods described herein.

The memory of the computing device may be a volatile memory or a non-volatile memory. The memory may include one or more of a read only memory (ROM), random access memory (RAM), a flash memory, an electronic erasable program read only memory (EEPROM), or other type of memory. The memory may be removable from the computing device, such as a secure digital (SD) memory card. The various devices or computers are configured by firmware, software, and/or hardware.

The communication interface of the computing device may include any operable connection. An operable connection may be one in which signals, physical communications, and/or logical communications may be sent and/or received. An operable connection may include a physical interface, an electrical interface, and/or a data interface. The communication interface provides for wireless and/or wired communications in any now known or later developed format.

The positioning circuitry may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry may include suitable sensing devices that measure the traveling distance, speed, direction, and so on, of the computing device. The positioning system may also include a transceiver and correlation chip to obtain a GPS signal. The computing device receives location data from the positioning system. The location data indicates the location of the computing device.

In certain examples, dedicated hardware implementations, such as application specific integrated circuits, programmable logic arrays and other hardware devices, can be constructed to implement one or more of the methods described herein. Applications that may include the apparatus and systems of various examples can broadly include a variety of electronic and computer systems. One or more examples described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Although the present specification describes components and functions that may be implemented in particular embodiments with reference to particular standards and protocols, the claim scope is not limited to such standards and protocols. For example, standards for Internet and other packet switched network transmission (e.g., TCP, UDP, IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The plotter, program, browser, or application is a computer program. A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. Elements of a computer include a processor for performing instructions and one or more memory devices for storing instructions and data. The computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a LED (light emitting diode) monitor or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the internet.

The computing system can include clients and servers. A client and server may be remote from each other and may interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the claim scope or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can be integrated together in a single software product or packaged into multiple software products.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, subject matter may be directed to less than all of the features of any of the disclosed embodiments. Thus, the following claims are incorporated into the Detailed Description, with each claim standing on its own as defining separately claimed subject matter.

1. A vessel transceiver system for fishing gear position, the vessel transceiver system comprising:
a radio antenna on a first vessel; and
a satellite modem on the first vessel;
wherein the radio antenna and/or the satellite modem are configured to receive position information of ocean-based fishing gear from the ocean-based fishing gear; and
wherein the radio antenna and/or the satellite modem are configured to provide the position information to a second vessel.

2. The vessel transceiver system of claim 1 wherein the radio antenna is configured to receive the position information in a radio frequency, and wherein the satellite modem is configured to provide the position information to a second vessel.

3. The vessel transceiver system of claim 2 further comprising a cloud-based database, wherein the position information is provided to the second vessel via the cloud-based database.

4. The vessel transceiver system of claim 2 wherein the satellite modem is configured to provide the position information to the second vessel via short message service (SMS) communication.

5. The vessel transceiver system of claim 2 wherein the satellite modem is configured to provide the position information to the second vessel via satellite internet communications.

6. The vessel transceiver system of claim 1 further comprising an interface on the first vessel, the interface connectable to a plotter application or program so that the first position information is provided to the plotter application or program on the first vessel.

7. The vessel transceiver system of claim 1 further comprising a processor in a housing, the housing having an interface for the radio antenna and housing the satellite modem.

8. The vessel transceiver system of claim 1 wherein a processor is configured for user selection of other vessels, including the second vessel, with which the position information is shared.

9. The vessel transceiver system of claim 7 wherein the radio antenna and/or satellite modem are configured to receive position information for other ocean-based fishing gear associated with the second vessel, and wherein the processor is configured to display the position information of the other ocean-based fishing gear.

10. The vessel transceiver system of claim 7 wherein the radio antenna and/or satellite modem are configured to transceiver other data in addition to the position information from the ocean-based fishing gear, and wherein the processor is configured to cause transmission by the radio antenna and/or the satellite model of the other data with the position information.

11. A method for sharing fishing gear data, the method comprising:
receiving, via first electronic communications, the fishing gear data from the fishing gear of a first vessel;
establishing, with a user interface by an entity of the first vessel, other vessels with which to share the fishing gear data; and
sharing, via second electronic communications, the fishing gear data with the other vessels.

12. The method of claim 11 wherein receiving and sharing comprises receiving and sharing from the first vessel with a vessel transceiver comprising a radio transceiver and a satellite modem.

13. The method of claim 11 wherein receiving comprises receiving by radio communication from the fishing gear to the first vessel, and wherein sharing comprises sharing the fishing gear data via a cloud-based database and internet-communications to the other vessels.

14. The method of claim 11 wherein establishing comprises selection by an entity corresponding to the first vessel of the other vessels.

15. The method of claim 11 wherein sharing comprises sharing via short message service.

16. The method of claim 11 wherein receiving comprises receiving via satellite communication and wherein sharing comprises sharing via satellite communication.

17. The method of claim 11 wherein sharing comprises sharing by transmission from the first vessel to the other vessels.

18. The method of claim 11 wherein sharing comprises sharing a location of a region oriented around a position of the fishing gear as the fishing gear data.

19. The method of claim 11 further comprising planning a route to avoid other regions of fishing gear of another vessel based on shaving by the other vessel.

20. A method for sharing fishing gear data, the method comprising:
electronically receiving the fishing gear data from the fishing gear of a first vessel at the first vessel; and
sharing the fishing gear data with the other vessels by electronic communication from the first vessel.

21. The method of claim 20 further comprising establishing the other vessels with which to share the fishing gear data, and wherein sharing comprises sharing only with the other vessels.

22. The method of claim 20 wherein receiving comprises receiving by a radio transceiver of vessel transceiver on the first vessel, and wherein sharing comprises sharing via satellite communications using a satellite modem of the vessel transceiver on the first vessel.

23. A system for sharing of ocean-based fishing gear data, the system comprising:
a radio transmitter on ocean-based fishing gear;
a first transceiver on a first vessel, the transceiver configured to receive data from the radio transmitter;
a first satellite modem on the first vessel, the satellite modem configured to transmit the data to a server or database;
a second transceiver on a second vessel, the second transceiver configured to receive the data from the server or database.

24. The system of claim 23 wherein the second transceiver comprises a second satellite modem.

25. The system of claim 23 further comprising a processor, the processor configured to generate a user interface configured for user selection of the second vessel for sharing.
